(19) United States
(12) Patent Application Publication
(10) Pub. No.: US 2023/0243973 A1
(43) Pub. Date: Aug. 3, 2023

(54) REAL SPACE OBJECT RECONSTRUCTION WITHIN VIRTUAL SPACE IMAGE USING TOF CAMERA

(71) Applicant: Hewlett-Packard Development Company, L.P., Spring, TX (US)

(72) Inventors: Ling I. Hung, Taipei City (TW); David Daley, Taipei City (TW); Yih-Lun Huang, Taipei City (TW)

(21) Appl. No.: 17/588,552

(22) Filed: Jan. 31, 2022

(51) Int. Cl. G01S 17/894; G01S 7/4865; G02B 27/01

(52) U.S. Cl. CPC G01S 17/894; G01S 7/4865; G02B 27/0101; G02B 27/0172; G02B 2027/0138; G02B 2027/0178

(57) ABSTRACT

A depth image is acquired using a time-of-flight (ToF) camera. The depth image has two-dimensional (2D) pixels on a plane of the depth image. The 2D pixels correspond to projections of three-dimensional (3D) pixels in a real space onto the plane. For each 3D pixel, 3D coordinates within a 3D camera coordinate system of the real space are calculated based on 2D coordinates of the 2D pixel to which the 3D pixel corresponds within a 2D image coordinate system of the plane, the depth image, and camera parameters of the ToF camera. The 3D pixels are mapped from the real space to a virtual space. An object within the real space within an image of the virtual space is reconstructed using the 3D pixels as mapped to the virtual space.

### BACKGROUND

Extended reality (XR) technologies include virtual reality (VR), augmented reality (AR), and mixed reality (MR) technologies, and quite literally extend the reality that users experience. XR technologies may employ head-mountable displays (HMDs). An HMD is a display device that can be worn on the head. In VR technologies, the HMD wearer is immersed in an entirely virtual world, whereas in AR technologies, the HMD wearer's direct or indirect view of the physical, real-world environment is augmented. In MR, or hybrid reality, technologies, the HMD wearer experiences the merging of real and virtual worlds.

### BRIEF DESCRIPTION OF THE DRAWINGS

FIGS. 1A and 1B are perspective and block view diagrams, respectively, of an example head-mountable display (HMD) that can be used in an extended reality (XR) environment.

FIG. 2A is a diagram of an example HMD wearer and a real space object.

FIG. 2B is a diagram of an example virtual space in which the real space object of FIG. 2A has been reconstructed.

FIG. 3 is a diagram of an example non-transitory computer-readable data storage medium storing program code for reconstructing a real space object in virtual space.

FIG. 4 is a flowchart of an example method for calculating three-dimensional (3D) coordinates within a 3D camera coordinate system of 3D pixels corresponding to two-dimensional (2D) pixels of a depth image.

FIG. 5 is a diagram depicting example performance of the method of FIG. 4.

FIG. 6 is a flowchart of another example method for calculating 3D coordinates within a 3D camera coordinate system of 3D pixels corresponding to 2D pixels of a depth image.

FIG. 7 is a diagram depicting example performance of the method of FIG. 6.

FIG. 8 is a flowchart of an example method for mapping 3D pixels from real space to virtual space.

FIG. 9 is a flowchart of an example method for reconstructing a real space object within a virtual space image using 3D pixels as mapped to virtual space.

### DETAILED DESCRIPTION

As noted in the background, a head-mountable display (HMD) can be employed as an extended reality (XR) technology to extend the reality experienced by the HMD's wearer. An HMD can include one or multiple small display panels in front of the wearer's eyes, as well as various sensors to detect or sense the wearer and/or the wearer's environment. Images on the display panels convincingly immerse the wearer within an XR environment, be it a virtual reality (VR), augmented reality (AR), a mixed reality (MR), or another type of XR. An HMD can also include one or multiple cameras, which are image-capturing devices that capture still or motion images.

As noted in the background, in VR technologies, the wearer of an HMD is immersed in a virtual world, which may also be referred to as virtual space or a virtual environment. Therefore, the display panels of the HMD display an image of the virtual space to immerse the wearer within the virtual space. In MR, or hybrid reality, by comparison, the HMD wearer experiences the merging of real and virtual worlds. For instance, an object in the wearer's surrounding physical, real-world environment, which may also be referred to as real space, can be reconstructed within the virtual space, and displayed by the display panels of the HMD within the image of the virtual space.

Techniques described herein are accordingly directed to real space object reconstruction within a virtual space image, using a time-of-flight (ToF) camera. The ToF camera acquires a depth image having two-dimensional (2D) pixels on a plane of the depth image. The 2D pixels correspond to projections of three-dimensional (3D) pixels in real space onto the plane. For each 3D pixel, 3D coordinates within a 3D camera coordinate space of the real space are calculated based on 2D coordinates of the 2D pixels to which the 3D pixel correspond within a 2D image coordinate system of the plane, the depth image, and camera parameters of the ToF camera. The 3D pixels are then mapped from the real space to a virtual space, and an object within the real space is reconstructed within an image of the virtual space using the 3D pixels as mapped to the virtual space.

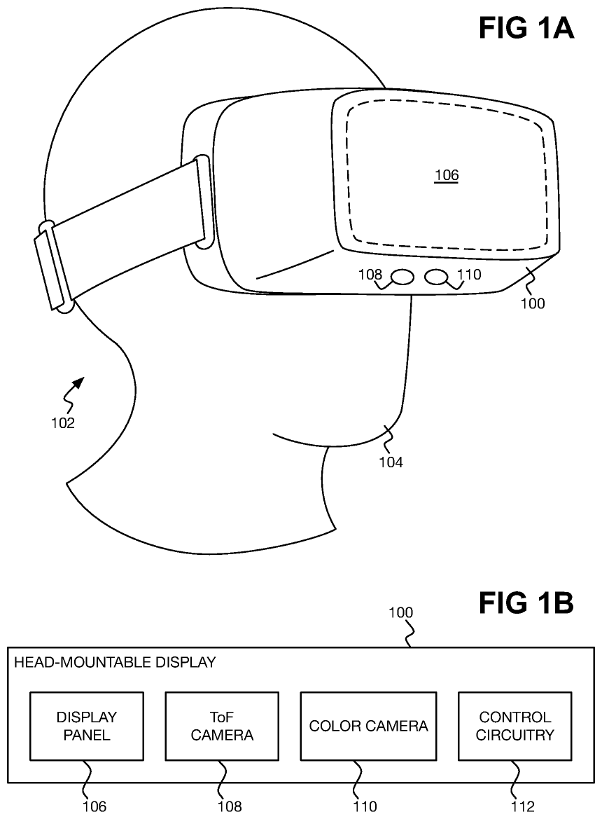

FIGS. 1A and 1B show perspective and block view diagrams of an example HMD 100 worn by a wearer 102 and positioned against the face 104 of the wearer 102 at one end of the HMD 100. The HMD 100 can include a display panel 106 inside the other end of the HMD 100 and that is positionable incident to the eyes of the wearer 102. The display panel 106 may in actuality include a right display panel incident to and viewable by the wearer 102's right eye, and a left display panel incident to and viewable by the wearer's 102 left eye. By suitably displaying images on the display panel 106, the HMD 100 can immerse the wearer 102 within an XR.

The HMD 100 can include an externally exposed ToF camera 108 that captures depth images in front of the HMD 100 and thus in front of the wearer 102 of the HMD 100. There is one ToF camera 108 in the example, but there may be multiple such ToF cameras 108. Further, in the example the ToF camera 108 is depicted on the bottom of the HMD 100, but may instead be externally exposed on the end of the HMD 100 in the interior of which the display panel 106 is located.

The ToF camera 108 is a range-imaging camera employing ToF techniques to resolve distance between the camera 108 and real space objects external to the camera 108, by measuring the round-trip time of an artificial light signal provided by a laser or a light-emitting diode (LED). In the case of a laser based ToF camera 108, for instance, the ToF camera may be part of a broader class of light imaging, detection and ranging (LIDAR) cameras. In scannerless LIDAR cameras, an entire real space scene is captured with each laser pulse, whereas in scanning LIDAR cameras, an entire real space scene is captured point-by-point with a scanning laser.

The HMD 100 may also include an externally exposed color camera 110 that captures color images in front of the HMD 100 and thus in front of the wearer 102 of the HMD 100. There is one color camera 110 in the example, but there may be multiple such color cameras 110. Further, in the example the color camera 110 is depicted on the bottom of the HMD 100, but may instead be externally exposed on the end of the HMD 100 in the interior of which the display panel 106 is located.

The cameras 108 and 110 may share the same image plane. A depth image captured by the ToF camera 108 includes 2D pixels on this plane, where each 2D pixel corresponds to a projection of a 3D pixel in real space in front of the camera 108 onto the plane. The value of each 2D pixel is indicative of the depth in real space from the ToF camera 108 to the 3D pixel. By comparison, a color image captured by the color camera 110 includes 2D color pixels on the same plane, where each 2D color pixel corresponds to a 2D pixel of the depth image and thus to a 3D pixel in real space. Each 2D color pixel has a color value indicative of the color of the corresponding 3D pixel in real space. For example, each 2D color pixels may have red, green, and blue values that together define the color of the corresponding 3D pixel in real space.

Real space is the physical, real-world space in which the wearer 102 is wearing the HMD 100. The real space is a 3D space. The 3D pixels in real space can have 3D (e.g., x, y, and z) coordinates in a 3D camera coordinate system, which is the 3D coordinate system of real space and thus in relation to which the HMD 100 monitors its orientation as the HMD 100 is rotated or otherwise moved by the wearer 102 in real space. By comparison, the 2D pixels of the depth image and the 2D color pixels of the color image can have 2D coordinates (e.g., u and v) in a 2D image coordinate space of the plane of the depth and color images.

Virtual space is the virtual space in which the HMD wearer 102 is immersed via images displayed on the display panel 106. The virtual space is also a 3D space, and can have a 3D virtual space coordinate system to which 3D coordinates in the 3D camera coordinate system can be mapped. When the display panel 106 displays images of the virtual space, the virtual space is transformed to 2D images that when viewed by the eyes of the HMD wearer 102 effectively simulate the 3D virtual space.

The HMD 100 can include control circuitry 112 (per FIG. 1B). The control circuitry 112 may be in the form of a non-transitory computer-readable data storage medium storing program code executable by a processor. The processor and the medium may be integrated within an application-specific integrated circuit (ASIC) in the case in which the processor is a special-purpose processor. The processor may instead be a general-purpose processor, such as a central processing unit (CPU), in which case the medium may be a separate semiconductor or other type of volatile or non-volatile memory. The control circuitry 112 may thus be implemented in the form of hardware (e.g., a controller) or in the form of hardware and software.

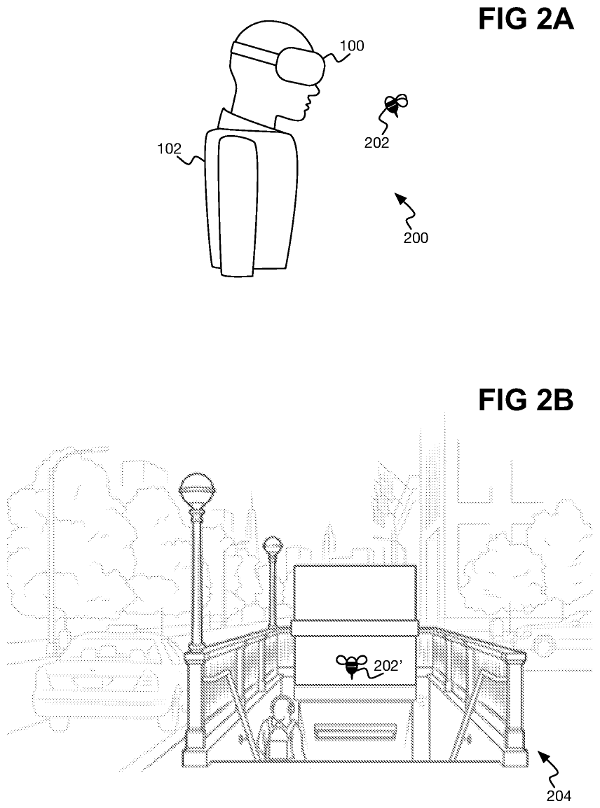

FIG. 2A shows the example wearer 102 of the HMD 100 in real space 200, along with a real space object 202, which is an insect, specifically a bee, in the example. The real space object 202 is an actual real-world, physical object in front of the HMD wearer 102 in the real space 200. The wearer 102 may be immersed within a virtual space via the HMD 100. Therefore, the object 202 in the real space 200 may not be visible to the wearer 102 when wearing the HMD 100.

FIG. 2B, by comparison, shows a virtual space 204 in which the wearer 102 may be immersed via the HMD 100. The virtual space 204 is not the actual real space 200 in which the wearer 102 is currently physical located. In the example, the virtual space 204 is an outdoor city scene of the stairwell entrance to a subway system. In the virtual space 204, though, the real space object 202 in the wearer 102's real space 200 has been reconstructed, as the reconstructed real space object 202′.

Therefore, the reconstructed real space object 202′ is a virtual representation of the real space object 202 within the virtual space 204 in which the wearer 102 is immersed via the HMD 100. For the real space object 202 to be accurately reconstructed within the virtual space 204, the 3D coordinates of the 3D pixels of the object 202 in the real space 200 are determined, such as within the 3D camera coordinate system. The 3D pixels can then be mapped from the real space 200 to the virtual space 204 by transforming their 3D coordinates from the 3D camera coordinate system to the 3D virtual space coordinate system so that the real space object 202 can be reconstructed within the virtual space 204.

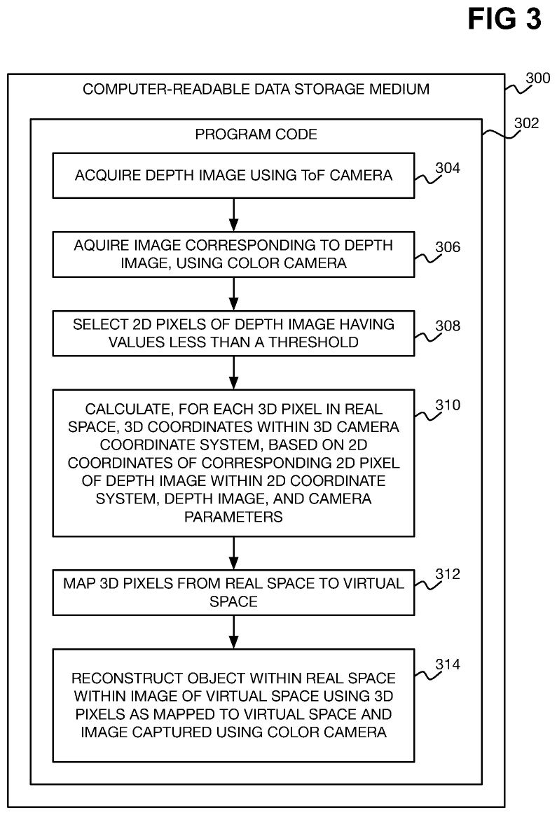

FIG. 3 shows an example non-transitory computer-readable data storage medium 300 storing program code 302 executable by a processor to perform processing. The program code 302 may be executed by the control circuitry 112 of the HMD 100, in which case the control circuitry 112 implements the data storage medium 300 and the processor. The program code 302 may instead be executed by a host device to which the HMD 100 is communicatively connected, such as a host computing device like a desktop, laptop, or notebook computer, a smartphone, or another type of computing device like a tablet computing device, and so on.

The processing includes acquiring a depth image using the ToF camera 108 (304). The processing can also include acquiring a color image corresponding to the depth image (e.g., sharing the same image plane as the depth image) using the color camera 110 (306). For instance, the depth and color images may share the same 2D image coordinate system of their shared image plane. As noted, each 2D pixel of the depth image corresponds to a projection of a 3D pixel in the real space 200 onto the image plane, and has a value indicative of the depth of the 3D pixel from the ToF camera 108. Each 2D color pixel of the color image has a value indicative of the color of a corresponding 3D pixel.

The processing can include selecting 2D pixels of the depth image having values less than a threshold (308). The threshold corresponds to which 3D pixels, and thus which objects, in the real space 200 are to be reconstructed in the virtual space 204. The value of the threshold indicates how close objects have to be to the HMD wearer 102 in the real space 200 to be reconstructed within the virtual space 204. For example, a lower threshold indicates that objects have to be close to the HMD wearer 102 in order to be reconstructed within the virtual space 204, whereas a higher threshold indicates that objects farther from the wearer 102 are also reconstructed.

The processing includes calculating, for the 3D pixel corresponding to each selected 2D pixel, the 3D coordinates within the 3D camera coordinate system (310). This calculation is based on the 2D coordinates of the corresponding 2D pixel of the depth image within the 2D image coordinate system of the plane of the depth image. This calculation is further based on the depth image itself (i.e., the value of the 2D pixel in the depth image), and on parameters of the ToF camera 108. The camera parameters can include the focal length of the ToF camera 108 to the plane of the depth image, and the 2D coordinates of the optical center of the camera 108 on the plane within the 2D image coordinate system. The camera parameters can also include the horizontal and vertical fields of view of the ToF camera 108, which together define the maximum area of the real space 200 that the camera 108 can image.

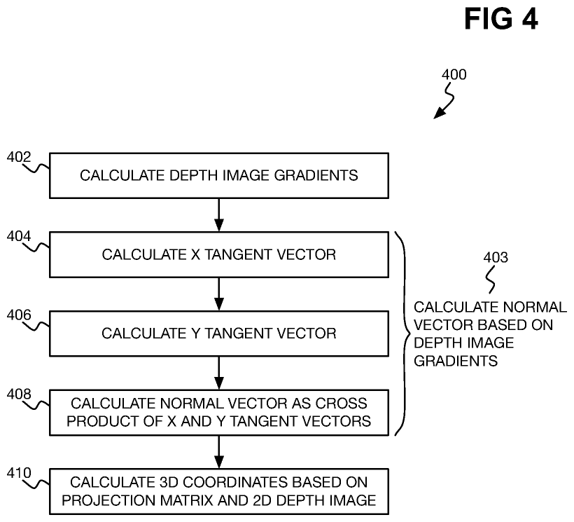

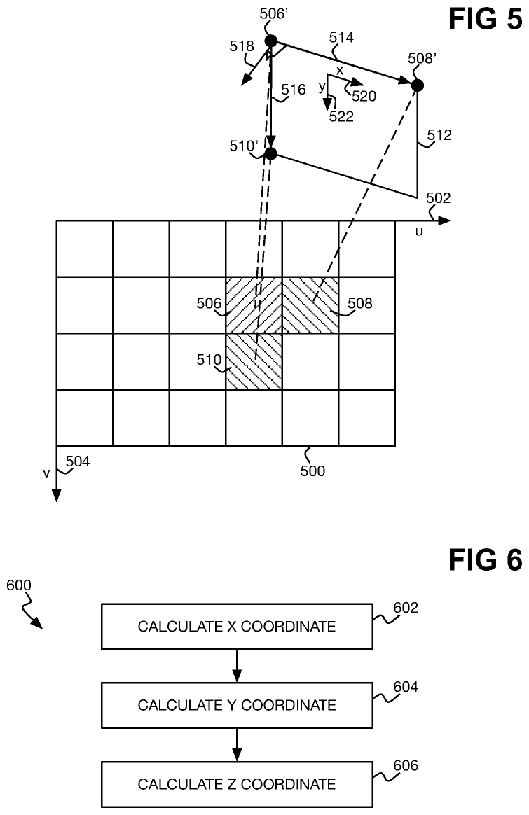

FIG. 4 shows an example method 400 conceptually showing how the 3D coordinates for each 3D pixel can be calculated, and FIG. 5 shows example performance of the method 400. The method 400 is described in relation to FIG. 5. The method 400 includes calculating depth image gradients for each 3D pixel (402). The depth image gradients may be calculated after first smoothing the depth image with a bilateral field. The depth image gradients may be computed with a first-order differential filter. A depth image gradient is indicative of a directional change in the depth of the image. The depth image gradients for each 3D pixel can include an x depth image gradient along an x axis, and a y depth image gradient along a y axis.

Per FIG. 5, for instance, the depth image 500 has an image plane defined by a horizontal u axis 502 and a vertical v axis 504. A selected 2D pixel 506 of the depth image 500 has a corresponding 3D pixel 506′. The 2D pixel 506 has a neighboring 2D pixel 508 along the u axis 502 that has a corresponding 3D pixel 508′, which can be considered a (first) neighboring pixel to the 3D pixel 506′ in real space. The 2D pixel 506 similarly has a neighboring 2D pixel 510 along the v axis 504 that has a corresponding 3D pixel 510′, which can be considered a (second) neighboring pixel to the 3D pixel 508′ in real space.

The 3D pixels 506′, 508′, and 510′ define a local 2D plane 512 having an x axis 520 and a y axis 522. The x depth image gradient of the 3D pixel 506′ along the x axis 520 is ∂Z(u,v)/∂x, where Z(u,v) is the value of the 2D pixel 506 within the depth image 500. The y depth image gradient of the 3D pixel 506′ along they axis 522 is similarly ∂Z(u,v)/∂y.

The method 400 includes calculating a normal vector for each 3D pixel based on the depth image gradients for the 3D pixel (403). Per FIG. 5, the 3D pixel 506′ has a normal vector 518. The normal vector 518 is normal to the local 2D plane 512 defined by the 3D pixels 506′, 508′, and 510′. In one implementation, the method 400 can calculate the normal vector for each 3D pixel as follows.

First, the x tangent vector for each 3D pixel is calculated (404), as is the y tangent vector (406). Per FIG. 5, the 3D pixel 506′ has an x tangent vector 514 to the 3D pixel 508′ and a y tangent vector 516 to the 3D pixel 510′. The x tangent vector 514 is vₓ(x,y)=(∂X(u,v)/∂x,∂Y(u,v)/∂x,∂Z(u,v)/∂x) and the y tangent vector 516 is vₓ(x,y)=(∂X(u,v)/∂y, ∂Y(u,v)/∂y, ∂Z (u,v)/∂_{y}). In these equations, X(u,v) and Y(u,v) are the neighboring 2D pixels 508 and 510, respectively, of the 2D pixel 506 having the corresponding 3D pixel 506′.

Second the normal vector for each 3D pixel is calculated as the cross-product of its x and y tangent vectors (408). Per FIG. 5, the normal vector 518 of the 3D pixel 506′ is thus calculated as n(x,y)=vₓ(x,y)×v_{y}(x,y). The normal vector for each 3D pixel constitutes a projection matrix. Stated another way, the projection matrix is made up of the normal vector for every 3D pixel.

The method 400 then includes calculating the 3D coordinates for each 3D pixel in the 3D camera coordinate system based on the projection matrix and the depth image (410). The projection matrix P is such that P_{2D}=P P_{3D}, where P_{2D} are the u and v coordinates of a 2D pixel of the depth image 500 within the 2D image coordinate system, and P_{3D} are the x and y coordinates of the corresponding 3D pixel within the 3D camera coordinate system (which are not to be confused with the x and y axes 520 and 522 of the local plane 512 in FIG. 5). The z coordinate of the corresponding 3D pixel within the 3D camera coordinate system is based on the value Z(u,v) of the 2D pixel in question within the depth image 500.

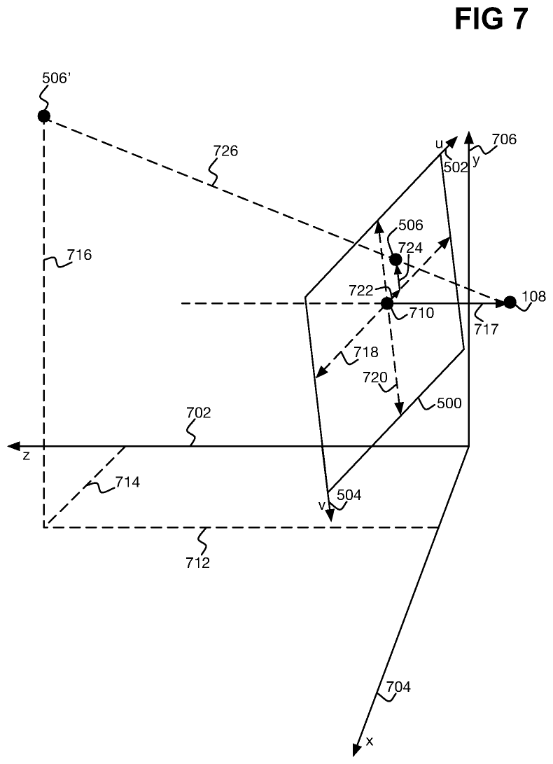

FIG. 6 shows an example method 600 showing in practice how the 3D coordinates for each 3D pixel can be calculated, and FIG. 7 shows example performance of the method 600. The method 600 is described in relation to FIG. 7. The method 600 is specifically how the conceptual technique of the method 400 can be realized in practice in one implementation.

The method 600 includes calculating the x coordinate of each 3D pixel within the 3D camera coordinate system (602), as well as the y coordinate (604), and the z coordinate (606). Per FIG. 7, the 3D camera coordinate system of the real space 200 has an x axis 704, a y axis 706, and a z axis 702. The 2D image coordinate system of the plane of the depth image 500 has the u axis 502 and the v axis 504, as before. The 2D pixel 506 of the depth image 500 has a corresponding 3D pixel 506′ within the real space 200. The ToF camera 108 has a focal center 710 on the plane of the depth image 500. The ToF camera 108 thus has a focal length 717 to the focal center 710. The depth image 500 itself has a width 718 and a height 720. The 2D pixel 506 has a distance 722 from the focal center 710 within the depth image 500 along the u axis 502, and a distance 724 along the v axis 504.

The x coordinate 714 of the 3D pixel 506′ within the 3D camera coordinate system is calculated based on the u coordinate of the 2D pixel 506, the focal length 717, the u coordinate of the focal center 710, the horizontal field of view of the ToF camera 108, and the value of the 2D pixel 506 within the depth image 500. They coordinate 716 of the 3D pixel 506′ within the 3D camera coordinate system is similarly calculated based on the v coordinate of the 2D pixel 506, the focal length 717, the v coordinate of the focal center 710, the vertical field of view of the ToF camera 108, and the value of the 2D pixel 506 within the depth image 500. The z coordinate 712 of the 3D pixel 506′ within the 3D camera coordinate system is calculated as the value of the 2D pixel 506 within the depth image 500, which is the projected value of the depth 726 from the ToF camera 108 to the 3D pixel 506′ onto the z axis 702.

Specifically, the x coordinate 714 can be calculated as x=Depth×sin(tan⁻¹((pᵤ−cᵤ)÷Focalᵤ)) and they coordinate 716 can be calculated as y=Depth×sin(tan⁻¹((pᵥ−cᵥ)÷Focalᵥ)). In this equation, Depth is the value of the 2D pixel 506 within the depth image 500 (and thus the depth 726), pᵤ and pᵥ are the u and v coordinates of the 2D pixel 506 within the 2D image coordinate system, and cᵤ and cᵥ are the u and v coordinates of the optical center 710 within the 2D image coordinate system. Therefore, pᵤ−cᵤ is the distance 722 and pᵥ−cᵥ is the distance 724 in FIG. 7. Focalᵤ, is the width 718 of the depth image 500 divided by 2 tan(fovᵤ/2), and Focalᵥ is the height 720 of the depth image 500 divided by 2 tan(fovᵥ/2), where fovᵤ, and fovᵥ are the horizontal and vertical fields of view of the ToF camera 108, respectively.

However, in some cases, either or both of the x coordinate 714 calculation and the y coordinate 716 calculation can be simplified. For instance, the calculation of the x coordinate 714 can be simplified as x=Depth×(pᵤ−cᵤ)÷Focalᵤ when Focalᵤ is very large. Similarly, the calculation of the y coordinate 716 can be simplified as y=Depth×(pᵥ−cᵥ)÷Focalᵥ when Focalᵥ is very large.

Referring back to FIG. 3, once the 3D coordinates for the 3D pixel corresponding to each selected 2D pixel has been calculated within the 3D camera coordinate system of the real space 200 per the methods 400 and/or 600, the processing includes mapping the 3D pixels from the real space 200 to the virtual space 204 (312). For instance, a transformation can be used (i.e., applied) to map the 3D coordinates within the 3D camera coordinate system of each 3D pixel to 3D coordinates within the 3D virtual space coordinate system. The transformation is between the 3D camera coordinate system and the 3D virtual space coordinate system, and can include both rotation and translation between the coordinate systems.

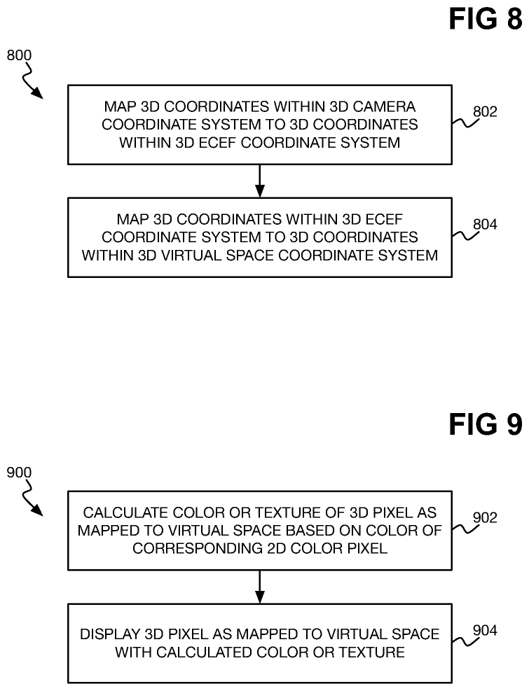

FIG. 8 shows an example method 800 for mapping a 3D pixel from the real space 200 to the virtual space 204 in another manner. The method 800 includes first mapping the 3D coordinates within the 3D camera coordinate system of the 3D pixel to 3D coordinates within a 3D Earth-centered, Earth-fixed (ECEF) coordinate system of the real space 200 (802), using a transformation between the former and latter coordinate systems. A 3D ECEF coordinate system is also referred to as a terrestrial coordinate system, and is a Cartesian coordinate system in which the center of the Earth is the origin. The x axis passes through the intersection of the equator and the prime meridian, the z axis passes through the north pole, and the y axis is orthogonal to both the x and z axes.

The method 800 includes then mapping the 3D coordinates within the 3D ECEF coordinate system of the 3D pixel to the 3D coordinates within the 3D virtual space coordinate system (804), using a transformation between the former coordinate system and the latter coordinate system. In the method 800, then, the 3D coordinates of a 3D pixel within the 3D camera coordinate system are first mapped to interim 3D coordinates within the 3D ECEF coordinate system, which are then mapped to 3D coordinates within the 3D virtual space coordinate system. This technique may be employed if the direct transformation between the 3D camera coordinate system and the 3ED virtual space coordinate system is not available.

Referring back to FIG. 3, once the 3D pixels have been mapped from the real space 200 to the virtual space 204, the processing includes reconstructing the object 202 represented by the 3D pixels within the real space 200 within an image of the virtual space 204 displayed by the HMD 100 of the wearer 102 (314). Such object reconstruction uses the 3D pixels as mapped to the virtual space 204. If a color image corresponding to the depth image 500 was captured with a color camera 110, the color image can also be used to reconstruct the object 202 within the image of the virtual space 204.

FIG. 9 shows an example method 900 for reconstructing an object 202 within the real space 200 within the virtual space 204 (900). If a color image corresponding to the depth image 500 was captured with a color camera 110, the method 900 can include calculating the color or texture of each 3D pixel of the object 202 as mapped to the virtual space 204 based on the color of the corresponding 2D color pixel within the color image (902). As one example, a color map calibrating the color space of the color camera 110 to that of the display panel 106 may be applied to the value of the 2D color pixel within the color image to use as the corresponding color of the 3D pixel within the virtual space 204.

The method 900 includes displaying each 3D pixel of the object 202 as mapped to the virtual space 204 within the image of the virtual space 204 (904). That is, each 3D pixel of the object 202 is displayed in the virtual space 204 at its 3D coordinates within the 3D virtual space coordinate system. The 3D pixel may be displayed at these 3D coordinates with a value corresponding to its color or texture as was calculated from the color image. If a color image is not acquired using a color camera 110, the 3D pixel may be displayed at these 3D coordinates with a different value, such as to denote that the object 202 is a real space object that has been reconstructed within the virtual space 204.

Techniques have been described for real space object reconstruction within a virtual space 204. The techniques have been described in relation to an HMD 100, but in other implementations can be used in a virtual space 204 that is not experienced using an HMD 100. The techniques specifically employ a ToF camera 108 for such real space object reconstruction within a virtual space 204, using the depth image 500 that can be acquired using a ToF camera 108.

We claim:

1. A non-transitory computer-readable data storage medium storing program code executable by a processor to perform processing comprising:
acquiring a depth image using a time-of-flight (ToF) camera, the depth image having a plurality of two-dimensional (2D) pixels on a plane of the depth image, the 2D pixels corresponding to projections of three-dimensional (3D) pixels in a real space onto the plane;
calculating, for each 3D pixel, 3D coordinates within a 3D camera coordinate system of the real space, based on 2D coordinates of the 2D pixel to which the 3D pixel corresponds within a 2D image coordinate system of the plane, the depth image, and camera parameters of the ToF camera;
mapping the 3D pixels from the real space to a virtual space; and
reconstructing an object within the real space within an image of the virtual space using the 3D pixels as mapped to the virtual space.

2. The non-transitory computer-readable data storage medium of claim 1, wherein calculating, for each 3D pixel, the 3D coordinates within the 3D camera coordinate system comprises:
calculating, for each 3D pixel, a plurality of depth image gradients based on the camera parameters of the ToF camera and a value of the 2D pixel to which the 3D pixel corresponds within the depth image and that corresponds to a depth of the 3D pixel from the ToF camera;
calculating, for each 3D pixel, a normal vector based on the depth image gradients, to generate a projection matrix made up of the normal vector for every 3D pixel; and
calculating, for each 3D pixel, the 3D coordinates within the 3D camera coordinate system, based on the projection matrix and the depth image.

3. The non-transitory computer-readable data storage medium of claim 2, wherein the depth image gradients for each 3D pixel comprises a u depth image gradient along an x axis, and a y depth image gradient along a y axis.

4. The non-transitory computer-readable data storage medium of claim 2, wherein calculating, for each 3D pixel, the normal vector comprises:
calculating, for each 3D pixel, an x tangent vector from the 3D pixel to a first neighboring 3D pixel in the real space, where the first neighboring 3D pixel in the real space has a first corresponding 2D pixel on the plane that neighbors the 2D pixel to which the 3D pixel corresponds along a u axis of the 2D image coordinate system;
calculating, for each 3D pixel, a y tangent vector from the 3D pixel to a second neighboring 3D pixel in the real space, where the second neighboring 3D pixel in the real space has a second corresponding 2D pixel on the plane that neighbors the 2D pixel to which the 3D pixel corresponds along a v axis of the 2D image coordinate system; and
calculating, for each 3D pixel, the normal vector as a cross product of the x tangent vector and the y tangent vector for the 3D pixel.

5. The non-transitory computer-readable data storage medium of claim 1, wherein the camera parameters of the ToF camera comprise:
a focal length of the ToF camera to the plane of the depth image;
2D coordinates of an optical center of the ToF camera on the plane of the depth image, within the 2D image coordinate system;
a vertical field of view of the ToF camera; and
a horizontal field of view of the ToF camera.

6. The non-transitory computer-readable data storage medium of claim 5, wherein calculating, for each 3D pixel, the 3D coordinates within the 3D camera coordinate system comprises:
calculating, for each 3D pixel, an x coordinate within the 3D camera coordinate system based on a u coordinate of the 2D pixel to which the 3D pixel corresponds within the 2D image coordinate system, the focal length of the ToF camera, a u coordinate of the optical center of the ToF camera within the 2D image coordinate system, the horizontal field of view of the ToF camera, and a value of the 2D pixel to which the 3D pixel corresponds within the depth image;
calculating, for each 3D pixel, a y coordinate within the 3D camera coordinate system based on a v coordinate of the 2D pixel to which the 3D pixel corresponds within the 2D image coordinate system, the focal length of the ToF camera, a v coordinate of the optical center of the ToF camera within the 2D image coordinate system, the vertical field of view of the ToF camera and the value of the 2D pixel to which the 3D pixel corresponds within the depth image; and
calculating, for each 3D pixel, a z coordinate within the 3D camera coordinate system as the value of the 2D pixel to which the 3D pixel corresponds within the depth image.

7. The non-transitory computer-readable data storage medium of claim 6, wherein calculating, for each 3D pixel, the x coordinate within the 3D camera coordinate system comprises calculating x=Depth×(pᵤ−cᵤ)÷Focalᵤ,
wherein calculating, for each 3D pixel, the y coordinate within the 3D camera coordinate system comprises calculating y=Depth×(pᵥ−cᵥ)÷Focalᵥ,
and wherein where Depth is the value of the 2D pixel to which the 3D pixel corresponds within the depth image, pᵤ and pᵥ are the u and v coordinates of the 2D pixel to which the 3D pixel corresponds within the 2D image coordinate system, cᵤ and cᵥ are the u and v coordinates of the optical center of the ToF camera within the 2D image coordinate system, Focalᵤ is a width of the depth image divided by 2 tan(fovᵤ/2), Focalᵥ is a height of the depth image divided by 2 tan(fovᵥ/2), and fovᵤ and fovᵥ are the horizontal and vertical fields of view of the ToF camera.

8. The non-transitory computer-readable data storage medium of claim 6, wherein calculating, for each 3D pixel, the x coordinate within the 3D camera coordinate system comprises calculating x=Depth×sin(tan⁻¹((pᵤ−cᵤ)÷Focalᵤ)),
wherein calculating, for each 3D pixel, the y coordinate within the 3D camera coordinate system comprises calculating y=Depth×sin(tan⁻¹((pᵥ−cᵥ)÷Focalᵥ)),
and wherein where Depth is the value of the 2D pixel to which the 3D pixel corresponds within the depth image, pᵤ and pᵥ are the u and v coordinates of the 2D pixel to which the 3D pixel corresponds within the 2D image coordinate system, cᵤ and cᵥ are the u and v coordinates of the optical center of the ToF camera within the 2D image coordinate system, Focalᵤ, is a width of the depth image divided by 2 tan(fovᵥ/2), Focalᵥ is a height of the depth image divided by 2 tan(fovᵥ/2), and fovᵤ, and fovᵥ are the horizontal and vertical fields of view of the ToF camera.

9. The non-transitory computer-readable data storage medium of claim 1, wherein mapping the 3D pixels from the real space to a virtual space comprises:
mapping the 3D coordinates within the 3D camera coordinate system of each 3D pixel to 3D coordinates within a 3D virtual space coordinate system of the virtual space using a transformation between the 3D camera coordinate system and the 3D virtual space coordinate system.

10. The non-transitory computer-readable data storage medium of claim 1, wherein mapping the 3D pixels from the real space to a virtual space comprises:
mapping the 3D coordinates within the 3D camera coordinate system of each 3D pixel to 3D coordinates within a 3D Earth-centered, Earth-fixed (ECEF) coordinate system of the real space using a transformation between the 3D camera coordinate system and the 3D ECEF coordinate system; and
mapping the 3D coordinates within the 3D ECEF coordinate system of each 3D pixel to 3D coordinates within a 3D virtual space coordinate system of the virtual space using a transformation between the 3D ECEF coordinate system and the 3D virtual space coordinate system.

11. The non-transitory computer-readable data storage medium of claim 1, wherein reconstructing the object within the real space within the image of the virtual space comprises:
displaying each 3D pixel as mapped to the virtual space within the image of the virtual space.

12. The non-transitory computer-readable data storage medium of claim 1, wherein the processing further comprises:
acquiring an image corresponding to the depth image, using a color camera; the image having a plurality of 2D color pixels on the plane of the depth image and that correspond to the 2D pixels of the depth image, each 2D color pixel having a value corresponding to a color of the 2D color pixel,
and wherein reconstructing the object within the real space within the image of the virtual space comprises:
calculating a color or texture of each 3D pixel as mapped to the virtual space based on the color of the 2D color pixel corresponding to the 2D pixel of the depth image to which the 3D pixel corresponds; and
displaying each 3D pixel as mapped to the virtual space within the image of the virtual space with the calculated color or texture of the 3D pixel.

13. A method comprising:
acquiring, by a processor, a depth image using a time-of-flight (ToF) camera, the depth image having a plurality of two-dimensional (2D) pixels on a plane of the depth image;
selecting the 2D pixels having values within the depth image less than a threshold, the selected 2D pixels corresponding to projections of 3D pixels in a real space onto the plane;
calculating, by the processor for each 3D pixel, 3D coordinates within a 3D camera coordinate system of the real space, based on 2D coordinates of the selected 2D pixel to which the 3D pixel corresponds within a 2D image coordinate system of the plane, the depth image, and camera parameters of the ToF camera;
mapping, by the processor, the 3D pixels from the real space to a virtual space; and
reconstructing, by the processor, an object within the real space within an image of the virtual space using the 3D pixels as mapped to the virtual space.

14. A head-mountable display (HMD) comprising:
a time-of-flight (ToF) camera to capture a depth image having a plurality of two-dimensional (2D) pixels on a plane of the depth image, the 2D pixels corresponding to projections of three-dimensional (3D) pixels in a real space onto the plane; and
control circuitry to:
calculate, for each 3D pixel, 3D coordinates within a 3D camera coordinate system of the real space, based on 2D coordinates of the 2D pixel to which the 3D pixel corresponds within a 2D image coordinate system of the plane, the depth image, and camera parameters of the ToF camera;
map the 3D pixels from the real space to a virtual space; and
reconstruct an object within the real space within an image of the virtual space using the 3D pixels as mapped to the virtual space.

15. The HMD of claim 14, further comprising:
a color camera to capture an image corresponding to the depth image, the image having a plurality of 2D color pixels on the plane of the depth image and that correspond to the 2D pixels of the depth image, each 2D color pixel having a value corresponding to a color of the 2D color pixel,
wherein the control circuitry is further to calculate a color or texture of each 3D pixel as mapped to the virtual space based on the color of the 2D color pixel corresponding to the 2D pixel of the depth image to which the 3D pixel corresponds,
and wherein the control circuitry is further to reconstruct the object within the real space within the image of the virtual space by displaying each 3D pixel as mapped to the virtual space within the image of the virtual space with the calculated color or texture of the 3D pixel.
